(19) United States
(12) Patent Application Publication
(10) Pub. No.: US 2006/0027073 A1
(43) Pub. Date: Feb. 9, 2006

(54) Ergonomic drumstick grips

(76) Inventor: Gary P. Richard, Gloucester, MA (US)

Correspondence Address: Iandiorio & Teska, 260 Bear Hill Road, Waltham, MA, 02451-1018, US

(21) Appl. No.: 11/091,074

(22) Filed: Mar. 28, 2005

Related U.S. Application Data
(60) Provisional application No. 60/556,664, filed on Mar. 26, 2004.

(51) Int. Cl. G10D 13/02

(52) U.S. Cl. 84/422.4

(57) ABSTRACT

An ergonomic drumstick includes a plurality of rings forming ridges configured to circumferentially encompass a drumstick, the plurality of rings located non-equidistant from each other on the drumstick such that the rings ergonomically conform to the grip of a hand, the rings made from a softer material than the drumstick to provide comfort for the hand. The drumstick grip may be adjustable to provide greater comfort to the drummer's hand. Also, the drumstick grip may be removable to allow it to be transferred from one drumstick to another. The drumstick grip may also be provided with a color-coding to identify the type of drumstick grip.

### RELATED APPLICATIONS

This application claims benefit of U.S. Provisional Patent Application Ser. No. 60/556,664, filed on Mar. 26, 2004, entitled “DRUMSTICK GRIPS”, incorporated herein by this reference.

### FIELD OF THE INVENTION

The subject invention relates generally to drumstick grips and more specifically to ergonomic drumstick grips.

### BACKGROUND OF THE INVENTION

A drumstick is typically made from wood and may additionally include a wrap, tape or a single coating of rubber disposed over a portion of the drumstick. Drummers, however, may not prefer to use a bare drumstick, or even a drumstick with wrap, tape or a rubber coating, since these types of drumsticks can cause hand injury or discomfort and may not provide the drummer with sufficient control of the drumstick. Typical drumsticks can place stress on the joints in the hands and wrists which may result in injuries, such as carpal tunnel syndrome, tendonitis, or simple blisters to a drummer's hands. Even if the drumstick doesn't cause injury or fatigue to a drummer, a typical drumstick may be uncomfortable or not provide sufficient control for a drummer to grip the stick.

One prior solution to enhance gripping of a drumstick is for the drummer to use a pair of gloves. These gloves, however, may not be particularly comfortable, especially when a drummer begins to sweat while playing the drums. Moreover, gloves may not provide the feel and control desired by many drummers.

One prior drumstick provides ridges on the drumstick created by milling the wooden drumstick. One drawback to this type of drumstick is that nearly the whole drumstick has to be milled down just to provide the rings. Also, since the ridges are carved into the drumstick, they are fixed in place and are also made of the same material as the rest of the drumstick which may not be optimal for reducing fatigue to the drummer's hands. Also, the ridges may not be optimally located to reduce fatigue to the drummer's hands, or provide sufficient comfort, control and efficiency.

### BRIEF SUMMARY OF THE INVENTION

It is therefore an object of the subject invention to provide a more ergonomic drumstick grip.

It is a further object of this invention to provide such an ergonomic drumstick grip that provides greater gripping and control of the drumstick.

It is a further object of this invention to provide such an ergonomic drumstick grip that reduces fatigue and the potential for injury to the drummer.

It is a further object of this invention to provide such an ergonomic drumstick grip that reduces the vibration and other stresses that typically get transferred from the drumstick to the drummer's hands during use.

The subject invention results from the realization that a more ergonomic drumstick grip can be achieved by providing a plurality of adjustable rings that form ridges on the drumstick and circumferentially encompass a drumstick. The rings are ergonomically located to conform to the grip of a drummer's hand. The rings may be located non-equidistant from one another, may be in a spiral configuration, may have differing widths or may be integrated with a sleeve to provide greater comfort to a drummer's hands. The rings are preferably made from a softer material than the drumstick to provide comfort to a drummer's hands. Also, the drumstick grip may be removable such that it can be transferred from one drumstick to another.

The subject invention, however, in other embodiments, need not achieve all these objectives and the claims hereof should not be limited to structures or methods capable of achieving these objectives.

This invention features an ergonomic drumstick grip, including a plurality of rings forming ridges and configured to circumferentially encompass a drumstick, the plurality of rings located non-equidistant from each other on the drumstick such that the rings ergonomically conform to the grip of a hand, the rings made from a softer material than the drumstick to provide comfort for the hand.

In one embodiment, the rings may be removable from the drumstick. The rings of the grip may be adjustable on the drumstick. The rings may be integrated with a sleeve about the drumstick. The sleeve may include photoluminescent material. The rings may be spiral in configuration and co-joined to each other. A color of the rings may signify a drumstick grip type. The exterior surface of the rings may be textured. The rings may be made of neoprene. The rings may be made from a material selected from neoprene, PVC, one or more polymers, plastic or rubber. At least one of the rings may include an offset protrusion thereon. At least one of the rings may approximately form a cylinder. At least some of the rings may have different widths. At least some of the rings may include a weighted material. The inner surface of the rings may include a textured surface.

This invention also features an ergonomic drumstick grip, including a plurality of co-joined rings forming ridges and configured to circumferentially encompass a drumstick in a spiral configuration to ergonomically conform to the grip of a hand, the rings being made from a softer material than the drumstick for providing comfort to the hand.

In one embodiment, the grip may be removable from the drumstick. The rings of the grip may be adjustable on the drumstick. The grip may further include a coating applied on top of the drumstick grip. A color of the grip may signify a drumstick grip type.

This invention further features an ergonomic drumstick grip, including two or more rings forming ridges each having different widths and configured to circumferentially encompass a drumstick, the two or more rings located on the drumstick such that they ergonomically conform to the grip of a hand, the rings made from a softer material than the drumstick to provide comfort to the hand.

This invention also features an ergonomic drumstick end grip, including a sleeve configured to fit on the distal end of drumstick, the sleeve having one or more rings forming ridges to ergonomically conform to the grip of a hand, the sleeve made from a vibration absorption material to reduce the amount of vibration transmitted from a drumstick to a hand.

In one embodiment, the one or more rings may be integrated with a sleeve about the drumstick. The drumstick rings may be formed by molding the grip to a hand such that it can ergonomically conform to the grip of the hand. The vibration absorption material may include neoprene.

### BRIEF DESCRIPTION OF THE DRAWINGS

Other objects, features and advantages will occur to those skilled in the art from the following description of a preferred embodiment and the accompanying drawings, in which:

FIG. 1 is a schematic diagram of a drumstick grip, which is disposed on a drumstick, in accordance with the subject invention;

FIGS. 2 and 3 are schematic diagrams of another embodiment of the drumstick grip, which is disposed on a drumstick, in accordance with the subject invention;

FIGS. 4-6 are schematic diagrams of the rings of the drumstick grips shown in FIGS. 1-3, respectively, integrated with a sleeve;

FIGS. 7A-10A are schematic diagrams of yet another embodiment of drumstick grips, which are disposed on a drumstick, in accordance with the subject invention;

FIGS. 7B-10B are schematic diagrams of the drumstick grips shown in FIGS. 7A-10A, respectively, with each of the grips adjusted to conform to the grip of a user;

FIGS. 11 and 12 are schematic diagrams of the drumstick grips of FIGS. 7A and 9A, respectively, shown without a drumstick;

FIGS. 13-15 are schematic diagrams of the drumstick grips shown in FIGS. 1-3 in which the grips include a photoluminescent coating;

FIG. 16 is a schematic diagram showing alternate designs of the rings of the drumstick grip depicted in FIG. 13;

FIG. 17 is a schematic diagram showing an alternate design of the finger rings of FIG. 1;

FIGS. 18A and B are schematic diagrams showing an alternate design for the finger rings of FIG. 2 in which the rings include a weighted material;

FIGS. 19A-N are schematic diagrams showing alternate embodiments for the drumstick grip, which are disposed on a drumstick, in accordance with the subject invention;

FIGS. 20A-D are schematic diagrams of drumsticks that may be used with the drumstick grips shown in FIGS. 19A-N;

FIGS. 21A-D are schematic diagrams showing alternate designs of the drumstick grips of FIGS. 19A-N but with a reduced profile; and

FIG. 22 is a schematic diagram of an alternative embodiment of the drumstick grip shown in FIG. 1 in which the rings include a vibration dampening material.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

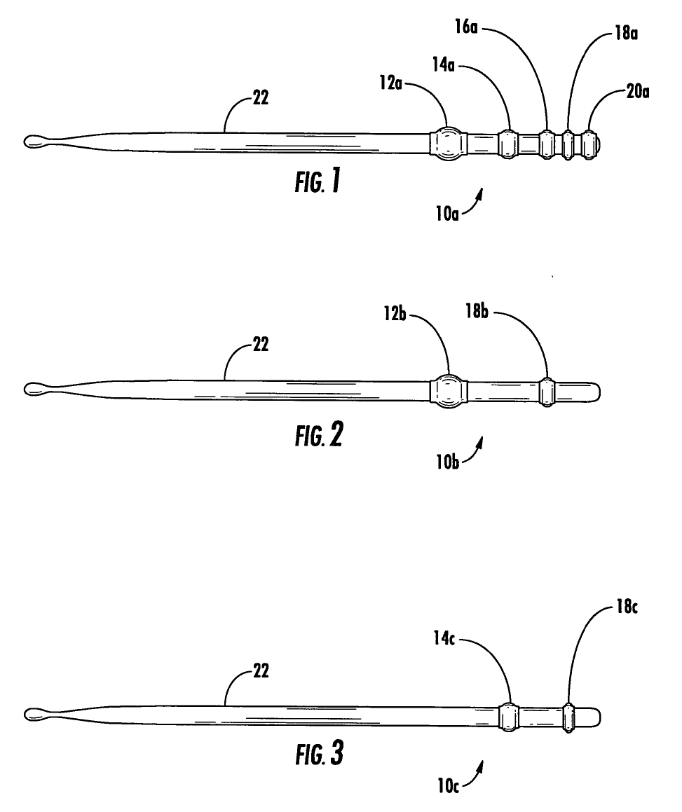

There is shown in FIG. 1 drumstick grip 10a of this invention including a plurality of rings 12a, 14a, 16a, 18a and 20a which form ridges on the drumstick and are configured to circumferentially encompass the handle of drumstick 22. Ring 12a is a thumb ring, ring 14a is an index finger ring, ring 16a is a middle finger ring, ring 18a is a ring finger ring, and ring 20a is a pinkie ring. Rings 12a-20a are located non-equidistant from each other on drumstick 22 such that rings 12a-20a ergonomically conform to the grip of a drummer's hand to provide comfort for the drummer. Because rings 12a-20a are adjustable and preferably located non-equidistant from each other, they more easily conform to the grip of a drummer's hand than rings which are spaced equally from each other because the grip of a typical drummer's hand does not conform to a drumstick grip in which all five rings are equally spaced from one another. Rings 12a-20a are preferably made from a softer material than drumstick 22, which is typically made from wood, to further provide comfort for the drummer's hands. An advantage of the subject invention is that it provides more natural finger placement on the drumstick grip since it takes into account that each drummer's fingers are different in size and length, and are angled when holding the drumstick in a playing mode to reach the drums.

In another embodiment of the invention, drumstick grip 10b, FIG. 2, includes rings 12b and 18b, which have different widths such that they ergonomically conform to the grip of a drummer's hand. Similar to rings 12a-20a , rings 12b and 18b are preferably made from a softer material than drumstick 22 to provide comfort to a drummer's hands. In this example, ring 12b is a thumb ring, whereas ring 18b is a ring finger ring.

Drumstick grip 10c, FIG. 3, includes rings 14c and 18c that have different widths and are located on drumstick 22 so that they also ergonomically conform to the grip of a drummer's hand. Some drummers may find it more beneficial to use drumstick grip 10c which includes index finger ring 14c and ring finger ring 18c, rather than using the grip 10b, FIG. 2, which includes thumb ring 12b and ring finger ring 18b. Although drumstick grips 10b and 10c, FIGS. 2 and 3, respectively, are shown as having only two rings, this is not a limitation of the invention since these grips can include any number of rings so long as they conform to the grip of a drummer's hand. Likewise, although grips 10b and 10c are shown with each ring having a different width, it should be understood that only one of the rings may need to have a different width to conform to the grip of a user's hand if there are more than two rings. Thus, the user can choose the appropriate type, number, and shape of the rings he or she desires, and adjust the location of the rings.

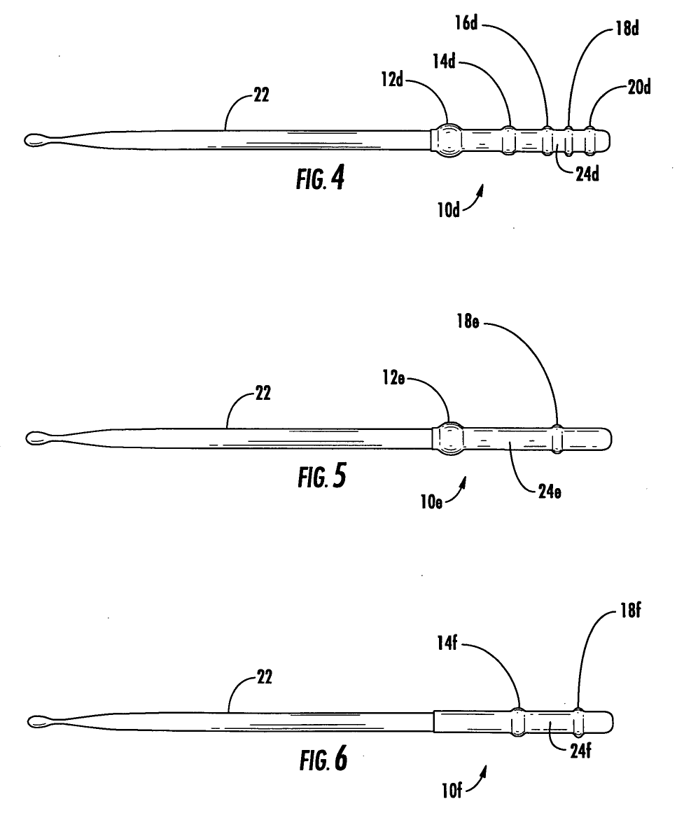

Drumstick grips 10d-10f, FIGS. 4-6, include sleeves 24d-24f, respectively, integrated with the corresponding rings. Sleeve 24d, 24e, or 24f may be integrated with rings 12d-20d, 12e-18e, or 14f-18f, respectively, by placing the sleeve over the rings, placing the rings over the sleeve, or by creating a single integrated sleeve and ring combination such as through a molding operation. Sleeves 24d-24f may be made from a rubberized type of solution, such as Plasti-Dip, made by Plasti-Dip International, located in Blaine, Minn. Sleeves 24d-24f may permanently locate the positions of their corresponding rings in place to provide a drummer with a secure and comfortable grip to grab drumstick 22.

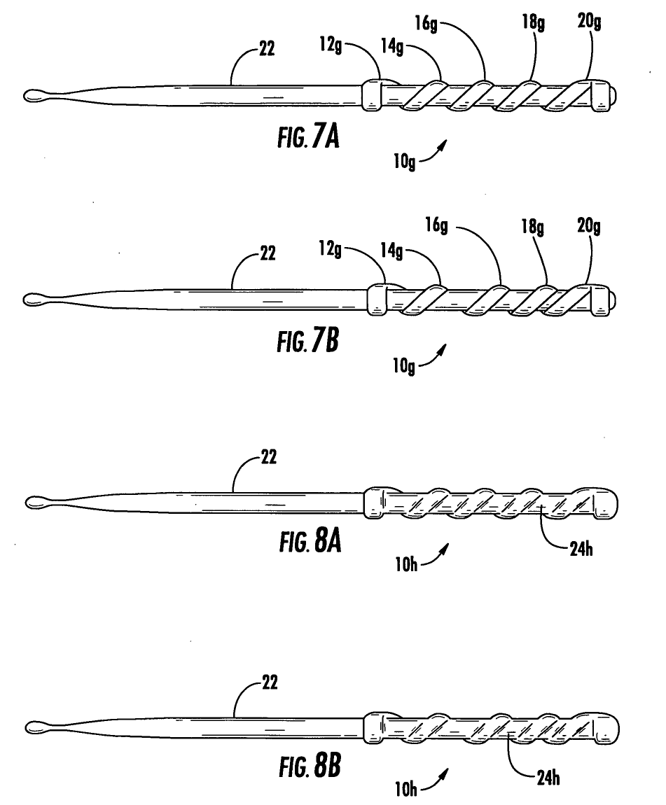

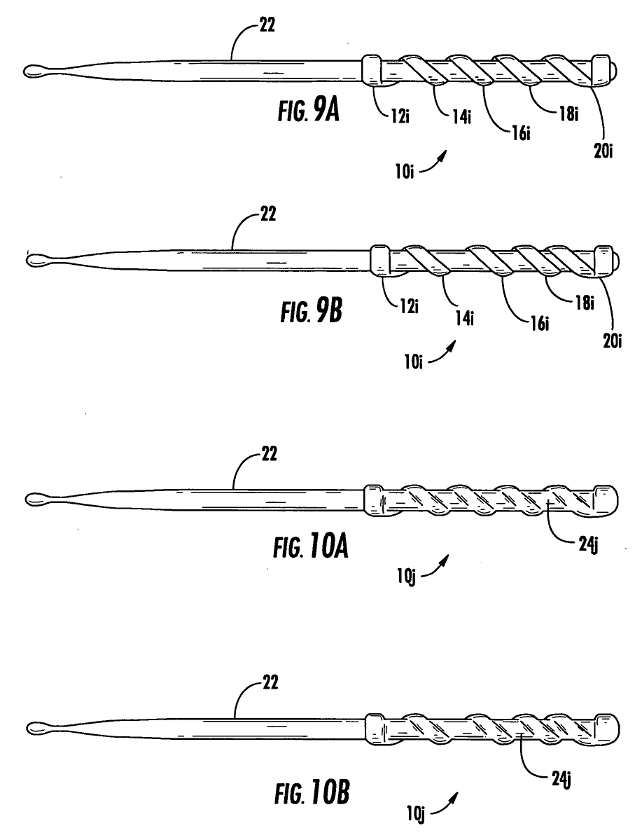

Another embodiment of a drumstick grip 10g, FIG. 7A, includes a plurality of co-joined rings 12g, 14g, 16g, 18g and 20g forming ridges and configured to circumferentially encompass a drumstick in a spiral configuration. Rings 12g-20g are wound in a configuration that may be preferable for a drummer to use in his right hand. Drumstick grip 10i, FIG. 9A, includes rings 12i-20i similar to the rings of drumstick grip 10g but which are instead wound in a spiral configuration that a drummer may find preferable to use with his left hand. Drumstick grips 10h and 10j, FIGS. 8A and 10A, respectively, are similar to drumstick grips log and 10i, but each includes a sleeve 24h and 24j, respectively, integrated with the rings.

The rings of the drumstick grips described herein may be adjustable to provide greater comfort to the grip of a drummer's hand. Rings 12g-20g and 12i-20i of drumstick grips 10g and 10i, respectively, FIGS. 7B and 9B, are each shown adjusted from the positions shown in FIGS. 7A and 9A to conform to the grip of a particular drummer's hand. The spiral configuration of grips 10g and 10i also allow the rings of the grips to be locked in place such that the rings cannot easily move further once they are adjusted. Drumstick grips 10h and 10j, FIGS. 8B and 10B, are similar to grips 10g and 10i, FIGS. 7B and 9B, but each includes a sleeve 24h or 24j integrated with the rings of the drumstick grip.

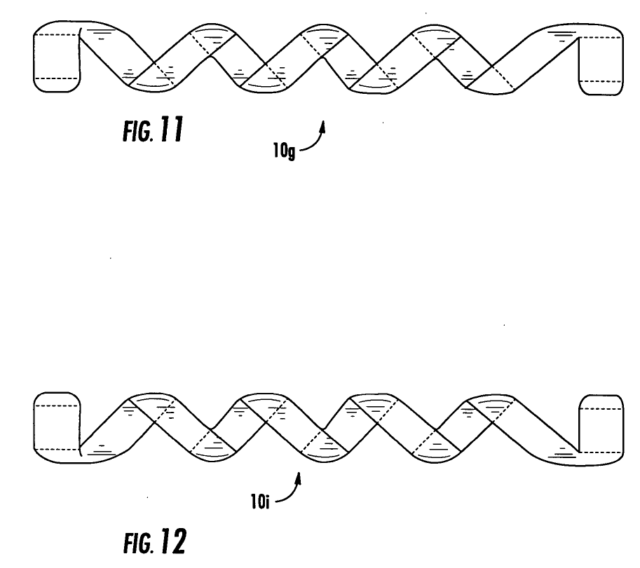

FIGS. 11 and 12 show drumstick grips 10g and 10i removed from a drumstick. Preferably, the drumstick grips disclosed herein are removable such that they can be used with any drumstick that a drummer may prefer.

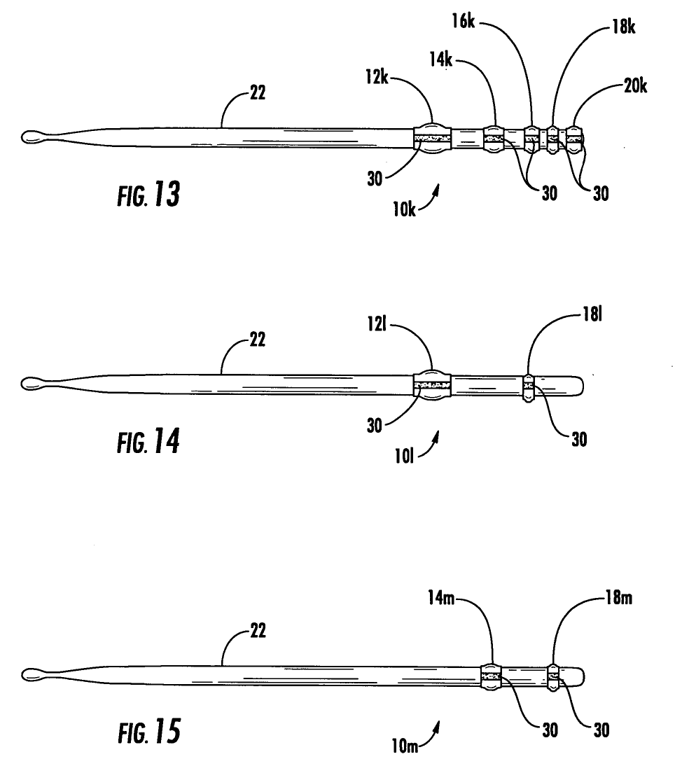

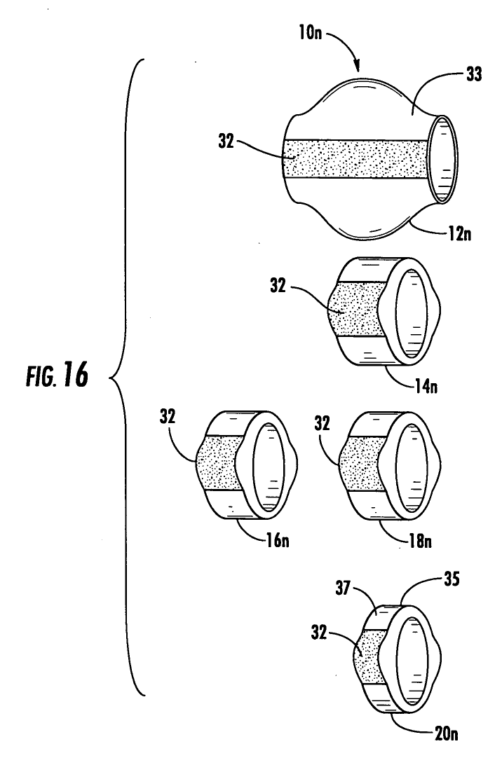

Drumstick grips 10k, 10l, and 10m, FIGS. 13-15, respectively, each include a photoluminescent coating 30 on each of the rings of their respective drumstick grip 10k-10m. Photoluminescent coating 30 may be provided to allow a drummer to locate a drumstick in a dark playing environment, or may provide a drummer with the ability to identify a particular type of drumstick grip. Drumstick grip 10n, FIG. 16, shows a different color-coded strip 32 on rings 12n, 14n, 16n, 18n, and 20n to identify drumstick grip 10n.

A ring, such as ring 12n of grip 10n, may also include an offset protrusion 33 thereon to provide a rest for a drummer's thumb. Alternatively, a ring, such as ring 20n, may approximately form a cylinder to provide a rest for one of the drummer's fingers. Ring 20n also includes textured surface 37 to aid a drummer in gripping ring 20n.

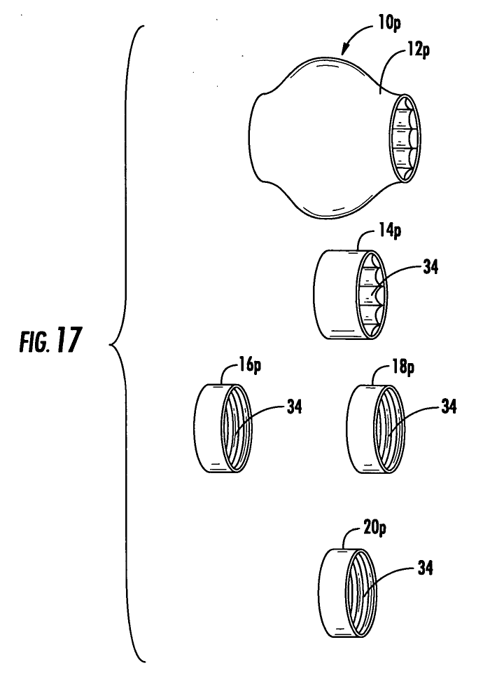

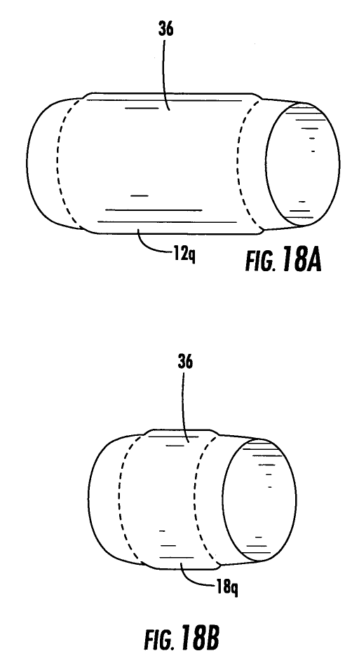

Rings 12p-20p of drumstick grip 10p, FIG. 17, include a textured surface 34, such as a ribbing, to aid in each ring gripping a drumstick. Textured surface 34 may also aid each ring in gripping different drumsticks having different diameters.

Rings 12q and 18q, FIGS. 18A and 18B, each which include weights 36 or other weighted material formed within each ring 12q or 18q to provide the drummer with weighted drumsticks for strength or speed training. The substrate material of ring 12q or 18q may be machined to create a recess to hold a strip of weighted material. Rings 12q and 18q may then be covered with coating, such as rubberized coating, to encapsulate weighted material 36.

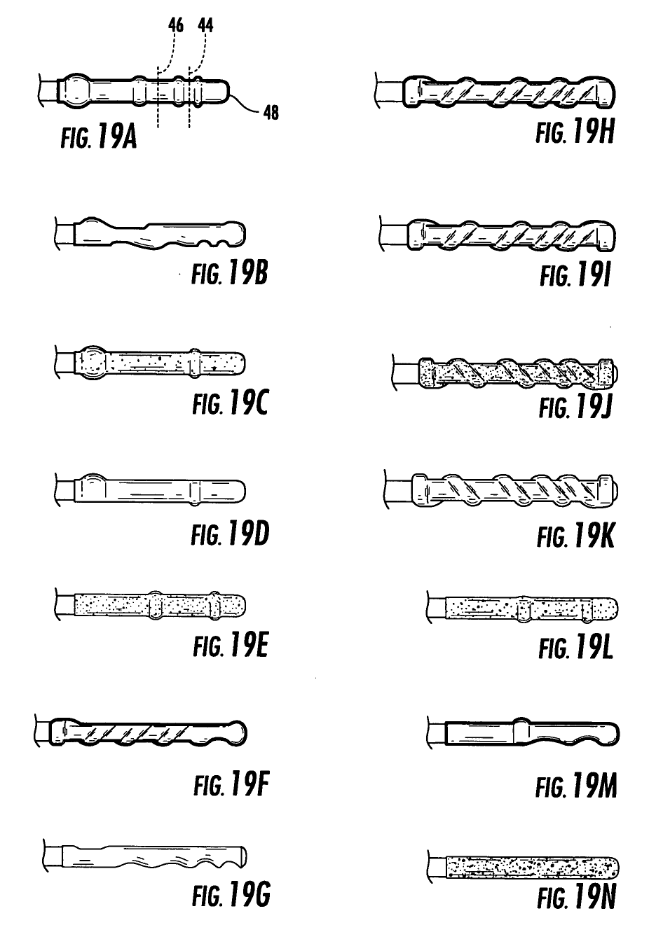

The drumstick grip shown in each of FIGS. 19A-19N each show a drumstick grip having a color that signifies the type of drumstick grip. A color-coding system as shown in FIGS. 19A-19N may help a drummer to easily identify the type of drumstick or drumstick grip if a drummer has a plurality of different types, especially when a drummer performs in a dark environment. The various styles of grips can be abbreviated in length to provide a sufficient amount of control while allowing a drummer to grasp more wood on the drumstick. For example, the drumstick grip in FIG. 19A may be shortened or cut at phantom lines 44 or 46 to provide two or three ridges from end 48 on the grip as shown.

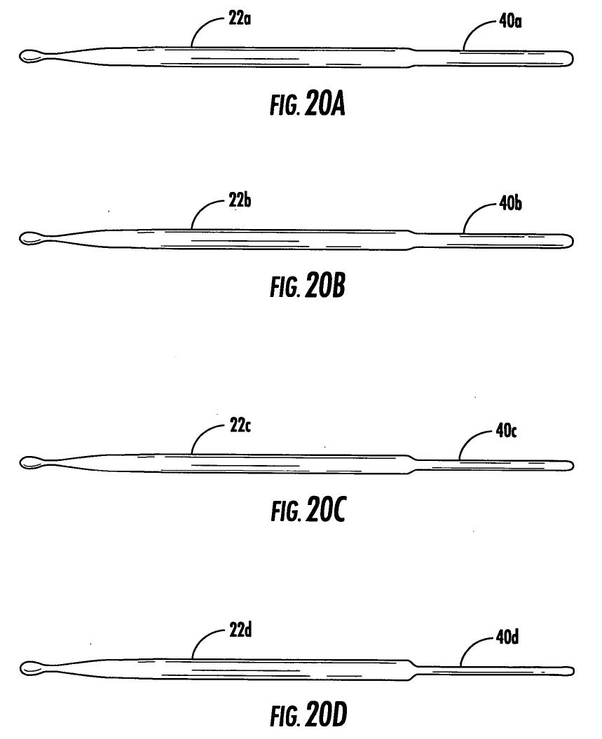

Drumsticks 22a-22d, FIGS. 20A-20D, each have a milled end 40a -40d in which a portion of the drumstick is removed, which allows a user to place a drumstick grip (not shown in FIGS. 20A-20D) so as not to significantly increase the diameter of the drumstick when the grip is placed thereon.

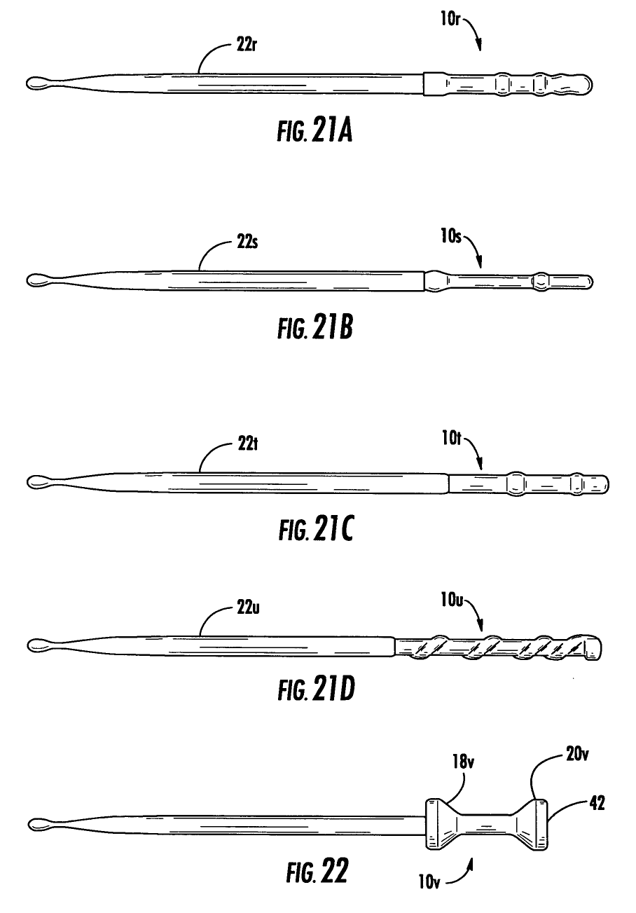

Drumstick grips 10r-10u, FIGS. 21A-21D, are disposed upon drumsticks, such as those shown in FIGS. 20A-20D to reduce the overall size of the drumstick and drumstick grip. Drumstick grips 10r-10u can be removable or integral with drumsticks 224-22u, respectively. In addition, drumstick grips I Or-10u include color-coding to signify each different type of drumstick grip.

Drumstick grip 10v, FIG. 22, includes a vibration absorption material 42 to dampen or decrease the vibration that is transmitted from the drumstick to a drummer's hand when playing. One type of vibration absorption material that may be used is neoprene, but other vibration absorption materials may be used to sufficiently reduce the vibration from the drumstick to the drummer's hands.

Each of the drumstick grips 10a-10v described herein is preferably made from material softer than the drumstick to provide comfort for a drummer's hands. The material selected for drumstick grips 10a-10v is preferably neoprene, but may be selected from other materials such as PVC, one or more polymers, plastic, rubber or any other material that would provide comfort to a drummer's hands while playing.

Drumstick grip 10v may also be formed by molding the drumstick grip to a user's hand so that it can ergonomically conform to the grip of a hand. It should be understood that any of the grips described herein may be created by molding or forming the grip to a drummer's hand to provide the rings and ridges as described.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. An ergonomic drumstick grip, comprising:
a plurality of rings forming ridges and configured to circumferentially encompass a drumstick, the plurality of rings located non-equidistant from each other on the drumstick such that the rings ergonomically conform to the grip of a hand, the rings made from a softer material than the drumstick to provide comfort for the hand.

2. The ergonomic drumstick grip of claim 1 in which the rings are removable from the drumstick.

3. The ergonomic drumstick grip of claim 1 in which the rings of the grip are adjustable on the drumstick.

4. The ergonomic drumstick grip of claim 1 in which the rings are integrated with a sleeve about the drumstick.

5. The ergonomic drumstick grip of claim 4 in which the sleeve includes photoluminescent material.

6. The ergonomic drumstick grip of claim 1 in which the rings are spiral in configuration and co-joined to each other.

7. The ergonomic drumstick grip of claim 6 in which a color of the rings signifies a drumstick grip type.

8. The ergonomic drumstick grip of claim 1 in which the exterior surface of the rings is textured.

9. The ergonomic drumstick grip of claim 1 in which the rings are made of neoprene.

10. The ergonomic drumstick grip of claim 1 in which the rings are made from a material selected from neoprene, PVC, one or more polymers, plastic or rubber.

11. The ergonomic drumstick grip of claim 1 in which at least one of the rings includes an offset protrusion thereon.

12. The ergonomic drumstick grip of claim 1 in which at least one of the rings approximately forms a cylinder.

13. The ergonomic drumstick grip of claim 1 in which at least some of the rings have different widths.

14. The ergonomic drumstick grip of claim 1 in which at least some of the rings include a weighted material.

15. The ergonomic drumstick grip of claim 1 in which the inner surface of the rings includes a textured surface.

16. An ergonomic drumstick grip, comprising:
a plurality of co-joined rings forming ridges and configured to circumferentially encompass a drumstick in a spiral configuration to ergonomically conform to the grip of a hand, the rings being made from a softer material than the drumstick for providing comfort to the hand.

17. The ergonomic drumstick grip of claim 16 in which the grip is removable from the drumstick.

18. The ergonomic drumstick grip of claim 16 in which the rings of the grip are adjustable on the drumstick.

19. The ergonomic drumstick grip of claim 16 further including a coating applied on top of the drumstick grip.

20. The ergonomic drumstick grip of claim 16 in which a color of the grip signifies a drumstick grip type.

21. An ergonomic drumstick grip, comprising:
two or more rings forming ridges each having different widths and configured to circumferentially encompass a drumstick, the two or more rings located on the drumstick such that they ergonomically conform to the grip of a hand, the rings made from a softer material than the drumstick to provide comfort to the hand.

22. An ergonomic drumstick end grip, comprising:
a sleeve configured to fit on the distal end of drumstick, the sleeve having one or more rings forming ridges to ergonomically conform to the grip of a hand, the sleeve made from a vibration absorption material to reduce the amount of vibration transmitted from a drumstick to a hand.

23. The ergonomic drumstick grip of claim 22 in which the one or more rings are integrated with a sleeve about the drumstick.

24. The ergonomic drumstick grip of claim 22 in which the drumstick rings are formed by molding the grip to a hand such that it can ergonomically conform to the grip of the hand.

25. The ergonomic drumstick grip of claim 22 in which the vibration absorption material includes neoprene.
